(19) United States
(12) Patent Application Publication
(10) Pub. No.: US 2004/0203344 A1
(43) Pub. Date: Oct. 14, 2004

(54) Method of radio transmission in a danger alarm system

(76) Inventors: Werner Schropp, Muenchen (DE); Karlheinz Schreyer, Wolfratshausen (DE)

Correspondence Address: BAKER & BOTTS, 30 ROCKEFELLER PLAZA, NEW YORK, NY, 10112

(21) Appl. No.: 10/233,217

(22) Filed: Sep. 3, 2002

(51) Int. Cl. H04B 7/15; H04M 3/42

(52) U.S. Cl. 455/11.1; 455/414.1

(57) ABSTRACT

A method for radiotransmission in a danger alarm system, operating by way of repeaters and permitting a free choice of the intended recipient participants. For each participant a list is deposited in which, for intended recipient participants reachable directly, an address is stored, and for participants not reachable directly, the address of an intermediating participant. Thus, information can be exchanged individually among the participants in a danger alarm system.

The invention relates to a method of radiotransmission in a danger alarm system for a plurality of participants using transmitters and receivers and storage means.

### BACKGROUND OF THE INVENTION

Radio is virtually an ideal transmission medium for use in buildings. Equipment using radiotechnology can be quickly installed and easily adapted to changing requirements. One disadvantage, however, is the relatively short range at carrier frequencies in the gigahertz band. If so-called “repeaters” are employed to enhance the range, the high energy consumption requires network-supplied equipment. This is especially true for radio equipment in the new “SRD” band between 868 and 870 M hz.

In equipment using repeaters for range enhancement, the information must reach its destination in a short time by way of a number of stations. For purposes of building safety (fire alarm, intrusion protection) this short time amounts to a few seconds; and for building automation (lighting equipment), less than one second. Accordingly, powerful computers are required to find the correct route through a widely ramified network where probabilities are examined, paths are pre-selected, statistics are set up, etc. All this requires storage space, computer performance, and last but not least, an amount of electrical energy which not even a year's supply using batteries is possible at the present time.

EP 0,833,288 discloses a method of radiotransmission in a danger alarm system in which data from an alarm sensor are transmitted to the central unit by way of additional alarm sensors as intermediate stations. For this purpose, a fixed hierarchical structure connecting the alarm sensors with each other is provided. This fixed structure does not permit free communication of the alarm sensors with each other.

### SUMMARY OF THE INVENTION

The object of the present invention is to specify a method of radio-transmission in a danger alarm system, suitable for repeater operation, maintaining brief reaction times, and making possible individual communication among the participants in the system. Accordingly, provision is made for telegrams from participants ready to transmit, to be transmitted to intended recipient participants by way of so-called intermediating participants, and for a list to be stored in a participant's storage means, in which the addresses of the intermediating participants are stored, in case the intended recipient participants cannot be reached directly. In order for various participants to be reached jointly, provision is made for the said list to cover group memberships as well. Where the frequency is altered, provision is further made for the list to indicate also on which frequency channel the intended recipient participant can be reached. Furthermore, a method with frequency alteration can be simplified in that a change of frequency channels may be made according to a formula known to all participants.

In the event of interference with transmission between two participants, provision is made for the intended recipient participant to be reached by way of other, intermediating participants.

In a further embodiment of the invention, provision is made for a designated participant to optimize the lists of the other participants, and transmit the lists so optimized to the other participants.

In a particularly simple method according to the invention, the participants, even at the first commencement of operation, are brought into a mode of configuration in which they search for the other participants, and include them in their lists when found. In this way, the configuration outlay can be minimized.

The reception means of the participants may be switched on at preassigned times, and participants ready to transmit send preambles containing the address of the participant who is to receive the preamble. If a reception means receives one of the preambles addressed to this reception means, then the reception means remains switched on until the complete preamble has been received. In the event that no preamble was received, the reception means is switched-off, in which case, the cycles are so chosen that the time interval in which the reception means is switched-off is greater by more than a factor of 5 than the time interval in which the reception means is switched-on. This method ensures that the receivers remain ready to operate on a battery, for example an inexpensive AA cell, for a number of years.

In yet another embodiment of the present method, the reception means, in switched-on condition, changes the reception frequency in such manner as to comply with the FCC regulations for “frequency hopping” currently in effect in the USA.

For a costly transmission, provision is made for only the starting time of the data telegram proper to be transmitted in the preamble, for the reception means to switch itself on at that starting time, and for the transmission-ready participant to send out the corresponding data telegram at that starting time.

Radio communication can be further reduced whereby the transmission-ready participant, in event of a desired transmission to several intended recipient participants, sends out the preamble only once, and the corresponding reception means remain switched-on until such time as the preamble has been received.

### BRIEF DESCRIPTION OF THE DRAWINGS

The present invention is disclosed in greater detail hereinbelow and with reference to the drawings in which:

FIG. 1 illustrates a schematic view of a danger alarm system with three participants;

FIGS. 2a and 2b illustrate examples of lists such as are stored in the storage means;

FIGS. 3a and 3b illustrate the lists of two participants in configuration mode;

FIGS. 4a, 4b and 4c illustrate the lists of three participants in configuration mode;

FIG. 5 illustrates the list of a participant in which the group membership of the several participants has been entered as well; and

FIG. 6 illustrates the list of a participant with frequency channels provided for the transmission.

### DETAILED DESCRIPTION OF THE INVENTION

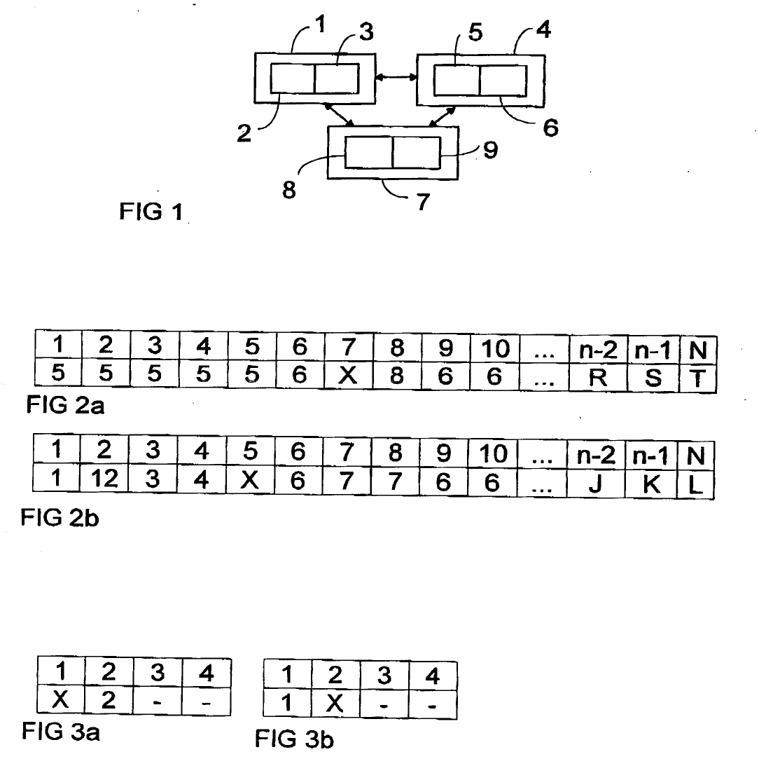

In FIG. 1, it is shown how a first participant 1 is equipped with a first transmitter 2 and a first receiver 3, the first participant 1 forming a danger alarm system with a second participant 4 (likewise having a second transmitter 5 and a second receiver 6), and with a third participant 7 (having a third transmitter 8 and a third receiver 9). The several participants 1, 4, 7 may comprise additional sensors, for example fire hazard detectors, or intrusion detectors such as motion alarms. The participants 1, 4, 7 may additionally assume central functions, for example initiate an alarm, or indicate a view of the building with the alarm locations in question. Conceivably also, the participants 1, 4, 7 may comprise servo drives to close doors, turn on lights or set blinds in motion.

The requisite HF receivers in the 1 Ghz range today typically consume 10 to 30 mA at 3 V. The service life of a battery should be about 4 years. For inexpensive AA cells (“Mignon”), such a current is 300 to 1000 times as great. The receiver regularly (for example, every 300 ms) checks whether a transmission-ready participant is active. The transient time of this receiver must be so small that the resulting mean current will not unduly tax the batteries. Technically possible at this time are transient times of less than 1 ms.

A transmission-ready participant will send a preamble enabling the receiver to recognize the inquiry. This preamble must be transmitted for 300 ms in order to ensure that the intended recipient participant (2) has his receiver switched-on at that time. This preamble need not necessarily be void; it may for example contain the entire data telegram. Additional information in the preamble may refer to the starting time of the telegram proper. The receiver is then switched-off until the start of the core information, thus saving current.

To comply with the FCC regulations on frequency change in force in the USA, the frequency of the reception channels is altered within the time during which the receiver is switched on.

If a transmission-ready station is to make contact with several other participants, the preamble is sent out only once, and the corresponding receivers for the intended recipient participants do not switch-off at once, but await the exchange of telegrams.

For the organization of the network, provision is made so that in a radio cell having for example n participants, each participant keeps a list containing information concerning by way of which next participant (intermediator) can reach an arbitrary other participant of the radio cell. Such a list is represented in FIG. 2a. In this list for participant 7, the participant to be reached is entered in the first line, and the first intermediator provided therefor in the second line. The participant 7 represented in FIG. 2a reaches participants 5, 6 and 8 directly, while participants 1 to 4 may be reached by way of participant 5, and participants 9 and 10 by way of participant 6. The statement that participant 2 may be reached by way of participant 5 does not mean that participant 5 has direct contact with participant 2. An additional intermediator may be provided, as represented in the exemplifying list of participant 5 in FIG. 2b.

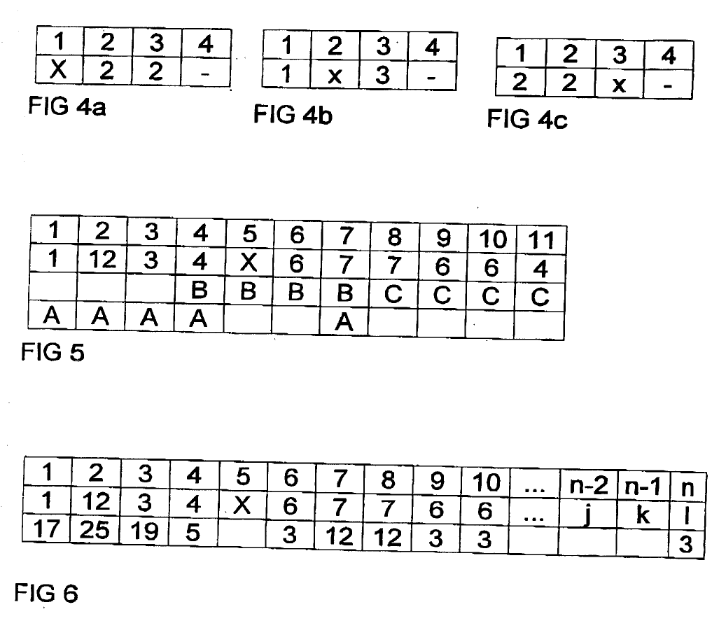

According to the present invention, provision is made for the first-time acquisition of the list to take place without additional “tool.” Here the following steps are gone through: the first participant of the radio cell is brought into a configuration mode. The participant searches for participants already present in configuration mode. Since the first participant finds no other such participants, this participant defines a cell number and waits for other participants to report to him. Next, the second participant of the radio cell is brought into configuration mode. He finds participant 1, and is integrated into the system as number 2. Both now have each occupied a place in their list, as represented in FIG. 3a for participant 1 and FIG. 3b for participant 2. Finally, the third participant is brought into configuration mode. If he finds only participant 2, but not participant 1, he has that one's list transmitted to him. Thus the third participant knows that he can reach participant 1 by way of participant 2. Participant 2 now transmits to participant 1 that participant 3 can reach (participant 2) by way of him. The corresponding stored lists then correspond for participant 1 to FIG. 4a, for participant 2 to FIG. 4b, and for participant 3 to FIG. 4c.

In case of loss of the connection between two participants n and m, n attempts to restore the connection by way of some other participant. For this purpose, said participant applies to those participants whom he can reach directly and checks whether they have contact with n. If so, participant n will correct his list accordingly. Similarly for participant m.

FIG. 5 shows that each participant of a radio cell may be assigned to one or more functional groups. These functional groups are imaged in additional lines of the lists, as represented in FIG. 5 by letters A, B and C. Thus, each participant, as represented, may belong to several groups at the same time, as is the case in the example of participant 6, who belongs simultaneously to groups A and B. By means of such groups, for example, collectives of lamps may be switched jointly.

Now if a broadcast message is sent to such a group, and a participant receives such a telegram and belongs to the indicated collective, then he executes the command, even if it is not addressed to him directly. In that case, no receipt is issued. In this way, the reaction time of a group can be shortened dramatically. A following command addressed directly with the same content remains without effect, but is receipted. To optimize the lists, provision is made for a designated participant of the cell to have the right to optimize the lists of the other participants. For that purpose, said designated participant collects the lists of all participants and optimizes them, for example in terms of additional attributes of the connections, such as field strength or error frequency. After the designated participant has optimized the network of connections of the cell, he sends the lists back to the several participants.

For systems with frequency change, additional provision is made for the lists to indicate by way of which frequency channel the particular participant may be reached in the next cycle. Such an example is shown in FIG. 6. The list represented in FIG. 6 applies to participant 5. If he is to send a telegram to participant 8, he applies to participant 7, using frequency channel No. 12. Since the channel numbers must be changed regularly, this has to take place within the scope of normal telegrams. Here, the future channel number of the old telegram is specified as well.

If the channel change is carried out according to a formula known to all participants, then even in the case where a telegram is lost, the corresponding party can phase himself back in by attempting to restore contact by way of the succeeding channels according to the formula.

Thus a current-sparing, spontaneously reacting radio system is represented, making possible battery-supplied repeaters. But the microcontrollers employed require only a small working memory. Despite the possibility of “autorouting,” one word per participant of the radio cell suffices.

1. A method of radiotransmission in a danger alarm system having a plurality of participants each comprising a transmitter and a receiver, whereby telegrams are transmitted from transmission-ready participants to an intended recipient participant by way of one or more intermediating participants, further comprising storing in a storage means associated with the participants, a list in which all intended recipient participants are assigned a list entry which, in the event of direct reachability of the intended recipient participant, is a number for that participant, and in event of absence of direct reachability, is a number of for next intermediating participant.

2. The method according to claim 1, further comprising assembling several participants in a group, with group membership noted in the list.

3. The method according to claim 2, wherein certain telegrams are sent to a group and said telegram's content is followed by participants who belong to the group addressed.

4. The method according to claim 1, further comprising providing in the list a frequency channel on which a participant may be reached.

5. The method according to claim 4, further comprising effecting a change of frequency channels according to a formula known to the participants.

6. The method according to claim 1, further comprising, in that in event of loss of a connection between two participants, having the transmission-ready participant query the participants reachable directly without the aid of intermediating participants as to whether an intended recipient participant can be reached by these to-be-reached participants, and that in the event that an intended recipient participant can be reached by way of another directly reachable participant, the list at the transmission-ready participant is corrected accordingly.

7. The method according to claim 1, further comprising transmitting the lists of participants to a designated participant which in turn optimizes the lists of the other participants, and sends the optimized lists to the other participants to be stored in a storage unit in place of the original list.

8. The method according to claim 1, further comprising configuring the participants in a configuration mode, and whereby the participants search for other participants in said configuration mode, and upon finding other participants include them in a list; and wherein information concerning participants who have not been found directly in the configuration mode, is transmitted by way of the intermediating participants to said participants, whereafter said participants are added to a list.

9. The method according to claim 1, further comprising switching on the receivers cyclically at preassigned points in time, and wherein the receivers in event of reception of a preamble, remain switched-on until the end of said preamble, and in the event that no preamble is received, are switched-off, so that a time interval during which the receiver is switched-off is greater by more than a factor of 5 than a time interval during which the receiver is switched-on.

10. The method according to claim 9, further comprising having the participant in communication change the frequency channel.

11. The method according to claims 9 and 10, wherein a start time of a data telegram is transmitted in the preamble, and the receiver after receiving the start time is switched-off and switched-on at said start time, and the transmission-ready participant at said start time sends out the telegram on his transmitter, and it is received by the receiver.

12. The method according to claim 9, wherein the transmission-ready participant, in event of a desired transmission to several intended recipient participants, sends out a preamble with corresponding recipient addresses once only.
